(19) United States
(12) Patent Application Publication
(10) Pub. No.: US 2020/0143433 A1
(43) Pub. Date: May 7, 2020

(54) METHOD FOR DIMISHED VALUE CALCULATION IN REPAIRED VEHICLES

(71) Applicant: Tony Rached, Roswell, GA (US)

(72) Inventor: Tony Rached, Roswell, GA (US)

(21) Appl. No.: 16/552,924

(22) Filed: Aug. 27, 2019

Related U.S. Application Data
(60) Provisional application No. 62/840,063, filed on Apr. 29, 2019.

(51) Int. Cl. G06Q 30/02; G06Q 10/00; G07C 5/00

(52) U.S. Cl. CPC G06Q 30/0278; G07C 5/008; G06Q 10/20

(57) ABSTRACT

The invention consists of a method for calculating diminished value in automobiles and other roadway vehicles. Diminished value is the inherent loss in resale value a vehicle suffers as a result of a collision, flood or other physical damage such that would require body work and repairs. This value is found by finding a range of potential values of analogous vehicles in order to establish the range of the loss, then applying a coefficient to that value to determine where in the range the damaged and repaired vehicle properly falls. The coefficient correlating to the damages is found by taking the average of sub-coefficients tied to the relative cost of repair, the amount of labor needed to fix the damage, and the degree of structural damage incurred. While it is commonplace on the market for the sale price of a refurbished automobile to be decreased as a result of repairs, to what degree the value should be decreased is unclear and existing methods are often imprecise, unsatisfactory and conclusory in nature.

### CROSS-REFERENCE TO OTHER APPLICATIONS

This application claims the benefit of U.S. provisional patent application No. 62/840,063 filed on Apr. 29, 2019, the entire content of which is incorporated herein by reference thereto.

### BACKGROUND OF THE INVENTION

When a vehicle is subject to a collision, flood, fire or other physical damage (Loss) it will often require body work and/or repairs. These repairs are intended to bring the vehicle back to its pre-loss condition but often fail to bring back the resale value prior to the loss in question. As a result, car shoppers are dissuaded from buying vehicles that have been damaged and repaired in favor of cars that have not been subject any damage or subsequent repairs. Due to the inherent bias favoring undamaged and unrepaired vehicles, the automotive marketplace reports lower resale values for vehicles who don't conform. Existing methods for establishing the diminished value of a vehicle are inaccurate, insufficient and often conclusory.

### BRIEF SUMMARY OF THE INVENTION

The invention consists of a method for calculating diminished value in automobiles and other roadway vehicles. In order to calculate the inherent loss in resale value a vehicle suffers as a result of a collision, flood or other physical damage such that would require body work and repairs. The methodology is primarily divided into two components. The first is the loss range, which is a measure of comparison between the highest and lowest recorded market values for a certain vehicle. The second is a damage coefficient, which is a ratio generated using a detailed description of the damages and repairs performed on the vehicle based upon a consideration of several components. The method consists of finding the diminished market value of the vehicle by finding the loss range and reducing it in the manner determined by the damage coefficient.

The loss range is found by taking the difference between the highest and lowest recorded values for a specific vehicle as reported by a third-party data aggregator. An example of a third party data aggregator would be a survey of executed auction transactions for similar vehicles with similar mileage and features with a 60 day period. Such a survey may, but does not necessarily need to include limitations for geographical data or yearly buying patterns, however such considerations may increase accuracy. The lowest sale value is subtracted from the highest sale value in the data set in order to find the difference, indicating the relative range in which a vehicle value can be reduced as a result of its condition. The loss range is then used as a benchmark for the repaired value of the vehicle by combining it with the damage coefficient.

The damage coefficient is a unique description of the specific damage suffered by the vehicle in question. This is found by finding the damage to value coefficient or “DVTC”, the labor coefficient or “LC”, and the structural damage coefficient or “SDC”. The DTVC is found by comparing the cost of repair to the pre-loss actual cash value or “ACV” of a vehicle. The LC is the number of technician hours required to bring the vehicle back to or as close to its pre-accident condition. The SDC is reflective of damage to the unibody or frame of a vehicle, which in turn is grounds for a reduction in the value due to purchasing stigma. These three values are averaged to find the damage coefficient, which is indicative of the portion of the loss range that is likely to be realized once repairs have been completed. The loss range is reduced according the damage coefficient and the resulting price indicates the diminished value of the vehicle.

### BRIEF DESCRIPTION OF THE DRAWINGS

FIG. 1 shows a sample calculation used to find the loss range for a certain vehicle. Auto Action data representing vehicles with a similar year, make, model, and mileage over a similar time frame is taken from a auto auction data aggregator. The range of potential prices for an analogous vehicle is found by subtracting the lowest value from the largest one. This value is used as the loss range.

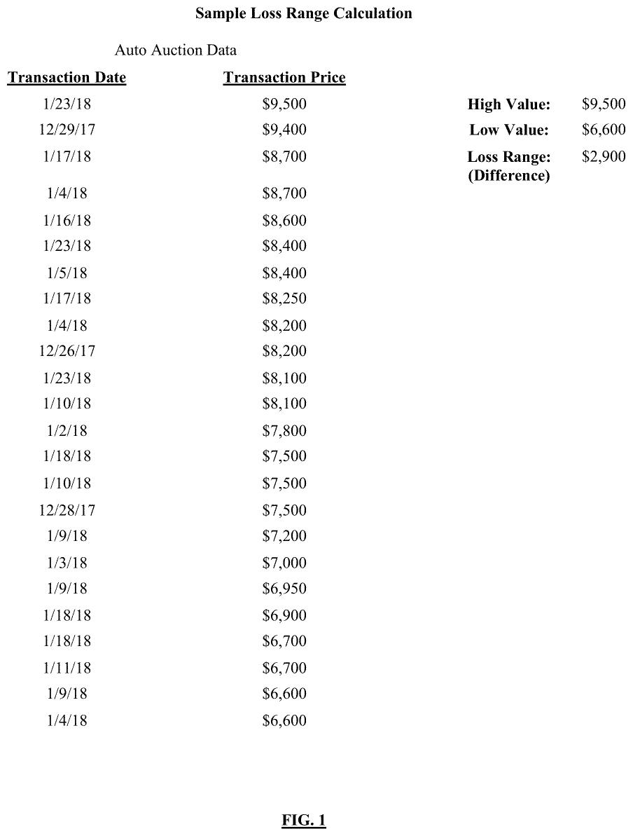

FIG. 2 shows the process by which the Damage to Value Coefficient or “DTVC” is found. First, the Damage to Value or “DTV” is calculated by dividing the cost of repair by the pre loss Actual Cash Value or “ACV”. The DTV is then adjusted according to the formula which accounts for a vehicle with a DTV over 75% as a total loss in order to find the DTVC. The graph included shows DTVC as a function of Pre-Loss Cash Value and DTV.

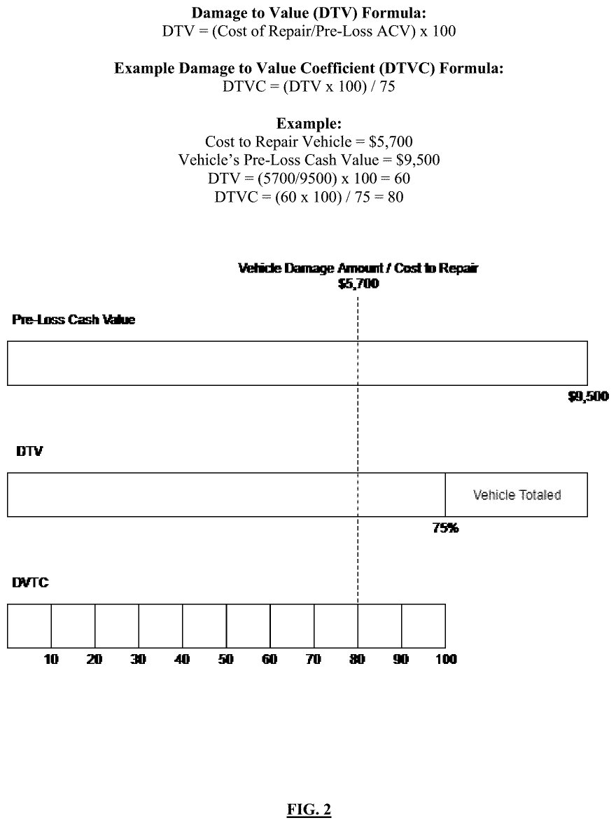

FIG. 3 depicts finding the labor coefficient or “LC”. The LC is found by taking the number of hours quoted or billed for vehicle repairs. Generally speaking, it does not take more than 100 hours to repair even a severely damaged vehicle. The graph shows a sample number of hours as it falls on a spectrum from minor damage to severe damage.

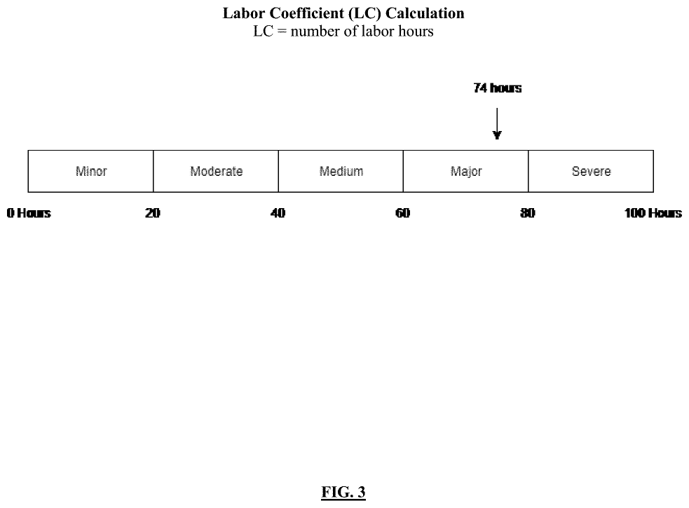

FIG. 4 depicts the finding of the Structural Damage Coefficient or “SDC” calculation. The figure shows the range of damages in which structural repairs are likely to occur. Typically a vehicle that would require more than 6 hours of structural repair is considered a total loss. An example calculation shows the formula by which the SDC is calculated.

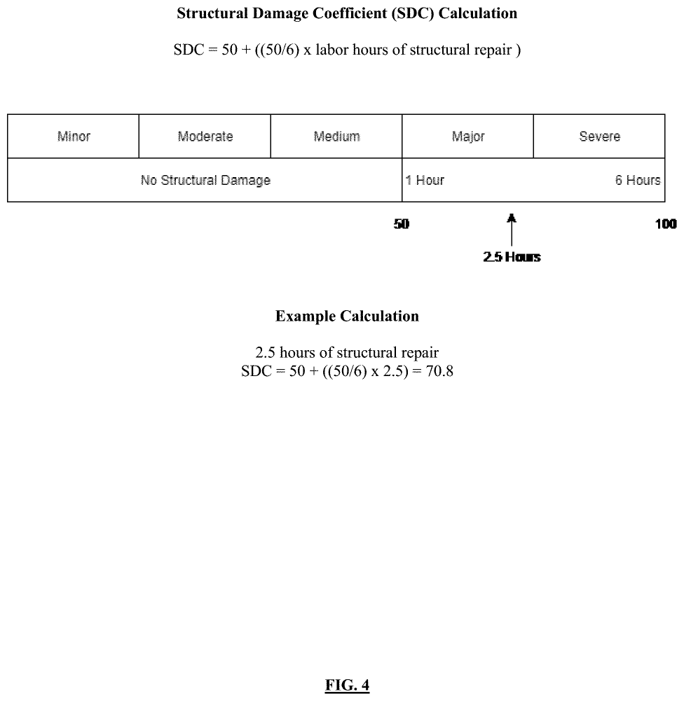

FIG. 5 Shows how empirical data is used to generate the sub-coefficients which are in turn used to find the overall Damage Coefficient or “DC”. The figure further shows how the DC is combined with the loss range to generate the diminished value of the vehicle. Diminished value in turn can be used to find the post-repair value of the vehicle being appraised.

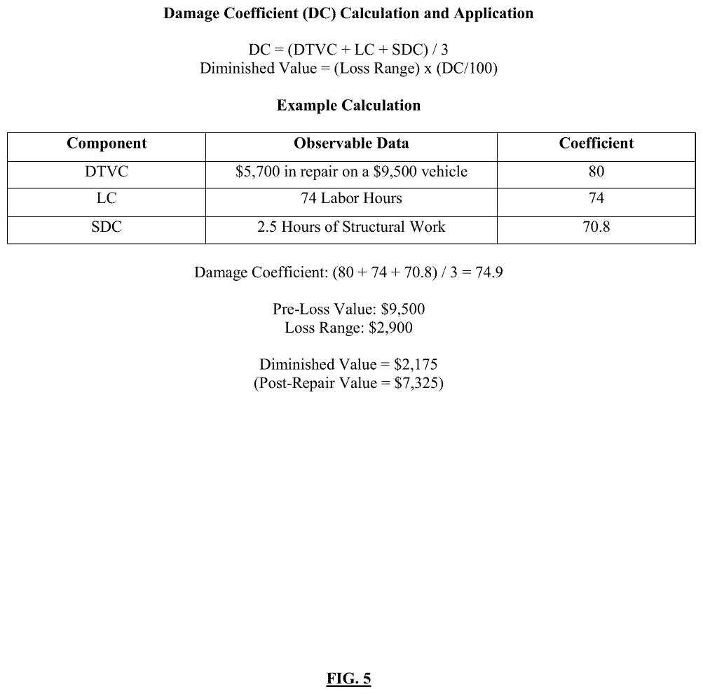

### DETAILED DESCRIPTION

The method disclosed is a means for finding the amount in which a vehicle's value is reduced as a result of damages after they have been repaired. This inherent loss in resale value is caused by a stigma against purchasing vehicles which have suffered damage as a result of a collision, flood, or any other event that gives rise to a need for repairs. The methodology comprises two general steps. The first is finding the range in which the likely reduction is to occur, and the second is applying a series of data points in order to determine where in that range the reduction in resale value is properly to be assessed.

The loss range is found using a set of recorded values for the sale of vehicles of a similar make and model and similar mileage. This data set can be refined in a number of ways, such as reducing the set to vehicles sales within a certain time frame or geographical region. The lowest value found in the set is indicative of the minimum value for which the vehicle is likely to sell, presumably as a result of damage or repairs of some fashion but still bearing inherent value. The highest value in the set in turn demonstrates the highest value for which an analogous vehicle has sold, presumably due to the fact that it is in excellent condition and has not required repairs or suffered substantial damage. The loss range is the difference between those two values which is found by subtracting the lowest value from the highest. Having found the range of values in which the diminished value is likely to occur, the diminished value itself is then found by applying the damage coefficient.

The damage coefficient is a unique description of the specific damage a subject vehicle has suffered. The overall damage coefficient is found by taking the average of three sub-coefficients; the damage to value coefficient or “DVTC”, the labor coefficient or “LC”, and the structural damage coefficient or “SDC”. The resultant score is indicative of the range in which the damage that has already occurred has effectively reduced the price of the vehicle within the loss range. Damage scores ranging from 0 to 20, representing a 0% to 20% loss of value, would be considered minor damage. Damage scores ranging from 20 to 40, representing a 20% to 40% loss of value, would be considered moderate damage. Damage scores ranging from 40 to 60, representing a 40% to 60% loss of value, would be considered medium damage. Damage scores ranging from 60 to 80 and 80 to 100 would be considered major and severe damage respectively. A vehicles diminished value would fall into one of these categories depending on the degree of damage it suffered and the resulting stigma driving down the purchase price.

The first value averaged is the DVTC, which is a factor that illustrates what percentile repair costs fall into with 0 being none whatsoever and 100 being barely short of being a total loss. Most insurance companies declare a vehicle a total loss when the cost of repair meets or exceeds 75% of the pre-loss actual cash value (ACV) of a vehicle. In order to find the DVTC, the damage to value or “DTV” formula is first calculated. The damage is divided by the pre-loss ACV and multiplied by 100 such that it is indicative of the percentage of the vehicles total value accounted for by repairs. If DTV is 75, it is in the 100^{th} percentile in terms of the degree of damage repaired as all vehicles with a DTV of greater than 75 would be considered a total loss. Thus, the DTVC is found by multiplying the DTV by 100 and dividing the resulting value by 75.

The second sub-coefficient is the labor coefficient or “LC”. Labor hours are the number of technician hours required to bring a vehicle back to pre-accident condition. Labor time is closely tied to cost and can often be extracted from repair cost estimates or quoted directly. A survey of repair estimates shows that a vehicle with medium damage requires a median of roughly 50 hours of Labor time, so in absence of a direct quote the DVTC can be used to estimate the LC as well.

The final sub coefficient that contributes to the damage coefficient is the structural damage coefficient or the “SDC”. Structural damage consists of damage to the unibody or frame of a vehicle. Structural damage is often the reason a vehicle is no longer considered to be sold as a certified pre-owned. Furthermore, structural damage creates additional purchasing stigma and results in the reduction of the vehicle's inherent value. Vehicles who suffer major damage typically have at least 2 hours of structural repair. Vehicles may have as much as 6 structural hours, but more than 6 likely would indicate a total loss. SDC is measured on a scale of 50 to 100, and is found by dividing 50 by 6 and multiplying the hours of structural repair then adding 50. For example, if a vehicle had 2.5 hours of structural repair it would have a SDC of 70.8.

The final damage coefficient is found by taking the average of the three sub-coefficients. For instance, consider a $9500 car that underwent $5700 worth of repairs, taking 74 total labor hours of which were 2.5 structural hours to repair. The DTVC would be 80, the LC would be 74, and the SDC would be 70.8; thus the damage coefficient would be 74.93. In other words, the damage coefficient is 75%. This value, aggregated from measures of empirical data used in repairs, provides a measure of how substantial the damage suffered by the vehicle was. In turn, this can be applied to the loss range to calculate diminished value, which can in turn be used to provide a post-repair value for the vehicle.

The exact diminished value is found by multiplying the loss range by the damage coefficient. As previously mentioned, the damage coefficient represents the degree of damages suffered by a vehicle and correlates with its value loss as a result of consumers' hesitance to purchase vehicles that have suffered damages. In turn, the loss range is reflective of the outer limits of the market value of a vehicle as a result of differences in condition and accident history. The resultant figure is the degree to which the value of a specific vehicle should be diminished to account for the repaired damage. When subtracted from the pre-loss value of the vehicle, it gives the post-repair value of the vehicle. Applications for the use of this information are vast as they provide a means for finding and measuring diminished value in a reliable and consistent fashion.

Using readily available data regarding repairs made on a damaged vehicle, this method can provide a formula to be used in the regular context in which a car that has been damaged is given a value after it has been repaired. Not only is this useful in pricing and selling cars, it is potentially valuable as a way to consider diminished value in addition to repair costs in terms of a vehicles finances and depreciations. The market has long felt a need for a concrete means of considering and projecting vehicle resale values after damage is repaired, which this invented method is capable of providing from obtainable information. Furthermore, the current invention does not require a large amount of computerized integration, complex calculations, or access to exclusive data to be employed.

What is claimed is:

1. A method for determining the value of a particular used vehicle, said used vehicle having suffered some form of substantial damage at some point that would require repairs, and said damage having been subsequently repaired by an auto mechanic or body shop, with the method comprising the steps of:
Determining a range of potential loss in vehicle value;
Determining a coefficient which correlates to the specific damage suffered by the particular used vehicle; and
Calculating, by applying the coefficient to the loss range, a fair resale value for the particular used vehicle.

2. The method of claim 1, where the loss range is found by examining a set of resale values for analogous vehicles to the particular used vehicle and subtracting the lowest value from the highest one.

3. The method of claim 1, where the damage coefficient is calculated by the further steps of:
Finding a first relative sub coefficient by comparing the cost of repairs to the value of the vehicle prior to the loss;
Finding a second relative sub coefficient by considering the number of labor hours required for the repair;
Finding a third relative sub coefficient by taking into account any structural damage to the particular vehicle; and
taking an average of the three relative sub coefficients.

4. The method of claim 1, where the particular used vehicle value is found by the further steps of:
Finding the diminished value of the particular used vehicle by multiplying the loss range by the damage coefficient divided by 100; and
Finding the particular used vehicle value by subtracting the diminished value from the pre-loss value of the vehicle.

5. The method of claim 3, where the first sub coefficient is found by the steps of:
Dividing the cost to repair the vehicle by the pre loss cash value and multiplying by 100 to find the Damage to Value coefficient; and
Multiplying the Damage to Value coefficient by 100 and dividing by 75 to account for the fact that vehicles with a cost to repair that is over 75% of their total pre-cash value are considered to be total losses.

6. The method of claim 3, where the second sub coefficient is the number of hours taken to repair the particular used vehicle.

7. The method of claim 3, where the third sub coefficient is found by multiplying the number of labor hours of structural repair by the value of 50 and divided by 6, then adding 50 to the resulting number.

8. The method of claim 3, where the damage coefficient calculation consists of taking an average value of the three sub coefficients.

9. A method for determining the value of a used vehicle that has been damaged and repaired, with repairs having consisted of 75% or less of the vehicle's pre loss value, found by the steps consisting of:
Determining a potential range of values for similar vehicles;
Determining a coefficient representative of the damage and repairs of the used vehicle; and
Applying the representative coefficient to the potential range of values to determine the diminishment of value.

10. The method of claim 9, where the potential range of values is found by the difference between the highest and the lowest amounts for which a similar vehicle has been valued over a relevant period of time.

11. The method of claim 9, where the representative coefficient is found by further steps consisting of:
Generating a ratio of cost of repairs versus value of the vehicle prior to being damaged;
Totaling the number of man hours needed for the repair;
Accounting for the degree to which structural repairs were necessary; and
Taking an average of the three numbers.

12. The method of claim 9, where the used vehicle value is found by calculating the diminished value of the used vehicle generated by applying the representative coefficient to the potential range and subtracting the diminished value from the original pre-damaged value of the vehicle.

13. The method of claim 11, where the ratio of cost of repairs takes into account the limitation upon damages which would not exceed 75% of the pre-damage value of the vehicle, accounting for the fact that vehicles which suffer a greater degree of damage would be considered a total loss.

14. The method of claim 11, in which the accounting for the degree of structural repairs takes note of the generally small portion of overall hours structural repair work constitutes and modifies the number to represent the degree to which the vehicle approached a total loss.
